(19) United States
(12) Patent Application Publication
(10) Pub. No.: US 2026/0163835 A1
(43) Pub. Date: Jun. 11, 2026

(54) METHOD OF OPERATING A TELECOMMUNICATIONS NETWORK

(71) Applicant: BRITISH TELECOMMUNICATIONS PUBLIC LIMITED COMPANY, London, Greater London (GB)

(72) Inventors: Simon BEDDUS, London (GB); Fadi EL-MOUSSA, London (GB); Claudia CRISTINA, London (GB)

(21) Appl. No.: 18/707,514

(22) PCT Filed: Oct. 17, 2022
(86) PCT No.: PCT/EP2022/078837

§ 371 Date: May 3, 2024

(30) Foreign Application Priority Data
Nov. 5, 2021 (GB) 2115948.8

(51) Int. Cl. H04L 45/302; H04L 45/12; H04L 67/303; H04L 67/63

(52) U.S. Cl. CPC H04L 45/306; H04L 45/127; H04L 67/303; H04L 67/63

(57) ABSTRACT

A method (200) of operating a telecommunications network (100), the telecommunications network comprising a client device (110), a server (150) configured to provide a service for the client device, and a plurality of network nodes (140) communicatively connecting the client device and the server, in which said method comprises the steps of: identifying: characteristic information associated with the client device (220); the service for the client device (220); in dependence upon the identified service and characteristic information, a service capability requirement for the provision of the identified service to the client device (220); and capability information for each of the plurality of network nodes (220); determining a given network node of the plurality of network nodes to be suitable in response to the capability information of said network node satisfying the identified service capability requirement (230); and subsequently routing network communications associated with the identified service between the client device and the server via at least one of the plurality of network nodes that is determined to be suitable (240). An apparatus (120) for performing the aforementioned method is also disclosed.

### BACKGROUND

The “Internet of Things” (IoT) grants connectivity to traditionally non-networked devices, such as sensors (e.g. temperature or optical). Some applications of IoT devices include people counting (i.e. footfall measurement), monitoring of vehicular traffic, air quality analysis, temperature and other environmental measurement, and control systems for streetlights or vehicular traffic signals.

The number of IoT devices that are being connected to each other and to the “Cloud” over the Internet is estimated to be in the tens of billions. Furthermore, the use of IoT devices, particularly for sensing the environment, is growing. Many of these IoT devices have low processing power (and are, for example, based around a Raspberry Pi^{RTM}, a small factor PC or an Application-Specific Integrated Circuit). Accordingly, IoT devices typically transmit their data to a nearby gateway that has more compute, battery and/or network resources, and which is then responsible for communicating the data on to a remote server for providing a service for that data (e.g. storing, processing and/or responding) by means an application operating on the remote server.

As a result of the relatively rudimentary nature of IoT devices, IoT devices (especially those that operate in public areas) are prone to compromise by means of a malicious attack. Known malicious attacks include: denial of service; man-in-the-middle; malware; and botnets. For example, malware may be introduced as part of a malicious attack on a network or even by way of physical tampering. A single compromised device can then spread malware to other devices and networks resulting in attacks being replicated very quickly. Beyond malicious attacks, poor design and/or malfunction of an IoT device can also cause an IoT device, and in turn a network, to be compromised with detrimental consequences.

At the same time, in order to ensure efficient utilisation of computational resources, it may be desirable to configure a network such that an IoT device and its network connection have a sufficient, but also appropriate, level of security.

It is an aim of the present invention to at least alleviate some of the aforementioned problems.

### Statements of Invention

According to a first aspect of the present invention, there is provided a method of operating a telecommunications network, the telecommunications network comprising a client device, a server configured to provide a service for the client device, and a plurality of network nodes communicatively connecting the client device and the server, in which said method comprises the steps of: identifying: characteristic information associated with the client device; the service for the client device; in dependence upon the identified service and characteristic information, a service capability requirement for the provision of the identified service to the client device; and capability information for each of the plurality of network nodes; determining a given network node of the plurality of network nodes to be suitable in response to the capability information of said network node satisfying the identified service capability requirement; and subsequently routing network communications associated with the identified service between the client device and the server via at least one of the plurality of network nodes that is determined to be suitable.

Preferably, the determined suitability of a network node is subsequently stored as a part of the characteristic information associated with the client device.

Optionally, the method further comprises the step of, for each network node, comparing the service capability requirement and the capability information, thereby subsequently to perform the determining step.

Optionally, the method is performed by: an edge device for providing an access network for the client device to access the plurality of network nodes; the server; and/or by at least one of the plurality of network nodes.

Optionally, the capability information is identified in response to a request for retrieval and communication of capability information, said retrieval being performed by the network node to which the capability information pertains, from an entity from which said request originated. Optionally, the service capability requirement is identified in response to a request for retrieval and communication of the service capability requirement, said retrieval being performed by the server, from an entity from which said request originated.

Optionally, a suitable network node sufficiently, but not excessively, satisfies the identified service capability requirement, at least in comparison to a threshold requirement and/or to another network node of the plurality of network nodes.

Optionally, the service is requested by the client device or pushed to client device by the server. Optionally, the plurality of network nodes are interconnected so as to provide a plurality of routes for network communications to be communicated between the client device and the server.

Preferably, the characteristic information is retrieved from a network location (e.g. URL) provided by the client device, and in which said characteristic information is pre-defined. Optionally, the pre-defined information is provided directly by the client device or by a remote network resource identified by the client device.

Preferably, the characteristic information is comprised within a Manufacturer Usage Description (MUD) file.

Preferably, the characteristic information comprises observed characteristic information that is generated in dependence on monitored network communications associated with the client device within the telecommunications network.

Preferably, the network communications are monitored as to: data protocols; time and/or frequency of communication; bandwidth usage; network addresses; encryption type; and/or packet content.

Preferably, the characteristic information is indicative of a/an: type of the client device; function of the client device; type of data that is output by the client device; and/or operating status of the client device.

Preferably, the capability information is indicative of a security capability.

Optionally, the security capability is a capability to provide and/or a particular type of: firewall functionality; encryption functionality; Virtualised Private Network functionality; packet processing function (for example, deep packet inspection); and/or remediation functionality (for example, microsegmentation). Optionally, the capability information is identified in dependence upon the identified service.

Preferably, the service capability requirement is a required security capability.

Preferably, the service capability requirement is a required network function. Optionally, said network function is a/an: routing function, such as for determining a routing policy; and/or network quality assurance function.

Preferably, the capability information is indicative of the client device generating Personally Identifiable Information (PII).

Preferably, the routing of network communications is only performed via the at least one network node that is determined to be suitable. Preferably, the at least one network node provides an end-to-end connection between the client device and the server.

Preferably, the service is a network function and/or a data processing function. Preferably, said service is performed by a remote distributed computing system, and for example by a cloud computing system.

According to another aspect of the invention, there is provided a computer-readable carrier medium comprising a computer program, which, when the computer program is executed by a computer, causes the computer to carry out the steps of a method as described above.

According to yet another aspect of the invention, there is provided an apparatus for a telecommunications network, said telecommunications network comprising a client device, a server configured to provide a service for the client device, a plurality of network nodes communicatively connecting the client device and the server, the apparatus comprising: a processor configured to perform the steps of: identifying: characteristic information associated with the client device; the service for the client device; in dependence upon the identified service and characteristic information, a service capability requirement for the provision of the service by the server to the client device; and capability information for each of the plurality of network nodes; determining a given network node to be suitable in response to the capability information of said network node satisfying the identified service capability requirement; and subsequently routing network communications associated with the identified service between the client device and the server via at least one of the plurality of network nodes that is determined to be suitable. Preferably, the client device is in the form of an “Internet of Things” (“IoT”) device. Preferably, each network node is available to be in the form of a/an: network access point; router; gateway; switch; firewall; server; database; controller; processor; and/or virtualised network function.

Preferably, the apparatus comprises a communications interface for communicatively connecting to the telecommunications network, and at least the client device and/or server. Preferably, the apparatus is in the form of an edge device for providing an access network for the client device to access the plurality of network nodes, wherein the processor is provided, at least, as part of the edge device. Optionally, the client device is configured to access the plurality of network nodes only via the edge device, and more preferably said edge device is in the form of a gateway.

The invention includes any novel aspects described and/or illustrated herein. The invention also extends to methods and/or apparatus substantially as herein described and/or as illustrated with reference to the accompanying drawings. The invention is also provided as a computer program and/or a computer program product for carrying out any of the methods described herein and/or for embodying any of the apparatus features described herein, and a computer-readable medium storing thereon a program for carrying out any of the methods and/or for embodying any of the apparatus features described herein. Features described as being implemented in hardware may alternatively be implemented in software, and vice versa.

The invention also provides a method of transmitting a signal, and a computer product having an operating system that supports a computer program for performing any of the methods described herein and/or for embodying any of the apparatus features described herein.

Any apparatus feature may also be provided as a corresponding step of a method, and vice versa. As used herein, means plus function features may alternatively be expressed in terms of their corresponding structure, for example as a suitably-programmed processor.

Any feature in one aspect of the invention may be applied, in any appropriate combination, to other aspects of the invention. Any, some and/or all features in one aspect can be applied to any, some and/or all features in any other aspect, in any appropriate combination. Particular combinations of the various features described and defined in any aspects of the invention can be implemented and/or supplied and/or used independently.

As used throughout, the word ‘or’ can be interpreted in the exclusive and/or inclusive sense, unless otherwise specified.

The invention extends to a method of operating a telecommunications network and a telecommunications network as described herein and/or substantially as illustrated with reference to the accompanying drawings. The present invention is now described, purely by way of example, with reference to the accompanying diagrammatic drawings, in which:

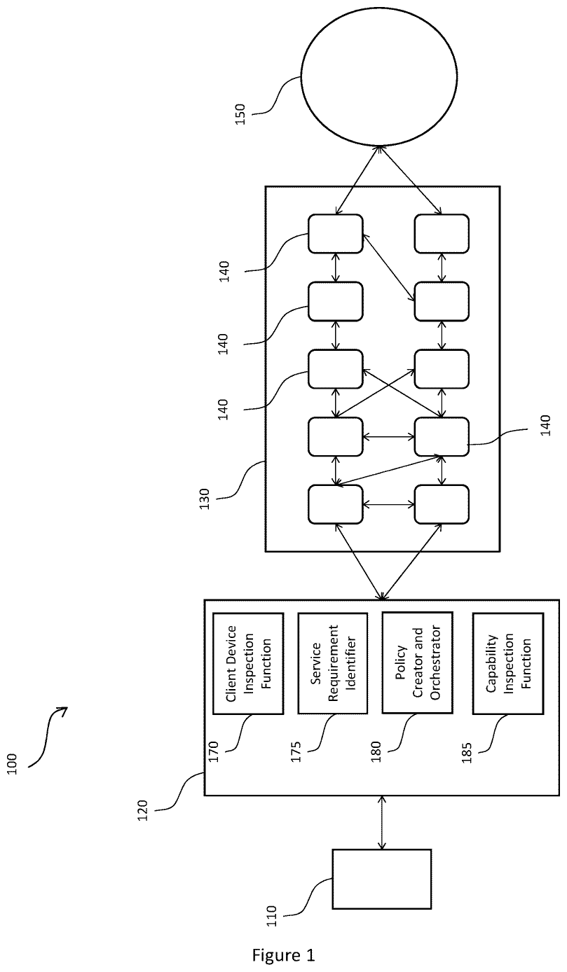

FIG. 1 shows a telecommunications system; and

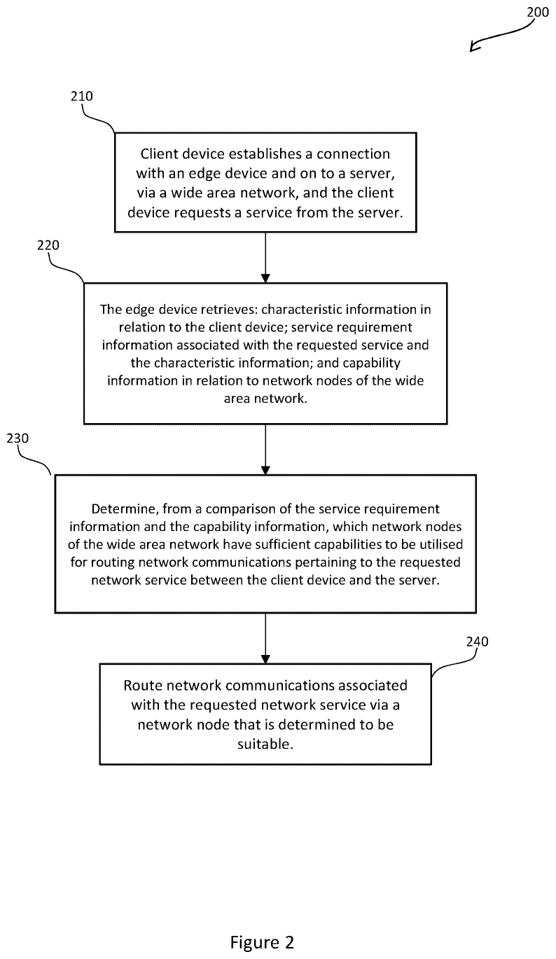

FIG. 2 shows a process for operating the telecommunications system.

### SPECIFIC DESCRIPTION

FIG. 1 shows an exemplary telecommunications system 100, which comprises a/an: client device 110; Edge Device (ED) 120; a wide area telecommunications network 130, comprising a plurality of nodes 140; and a sever 150.

The client device 110 is available communicatively to connect to the ED 120, which in turn is configured to provide the client device with access to the wide area network 130. The client device 110 is in the form of: a personal computer (laptop or desktop); mobile telecommunications device; and/or Internet of Things (IoT) device.

The ED 120 is available to be a wireless or wired access point for the wide area network 130, and is configured to provide a local area network (e.g. by means of Wi-Fi^{RTM}, Bluetooth^{RTM}, ZigBee^{RTM}, etc.) and/or cellular connectivity. The ED is therefore available to comprise a router, modem and/or network gateway. The ED is arranged in-line with user traffic that flows between the client device 110 and the wide area network 130, and is configured to process such traffic.

The wide area network 130 comprises a broadband and/or cellular telecommunications network that allows access to, at least, the server 150. The wide area network comprises a plurality of network nodes 140, which are functional components that help facilitate operation of the network 130, including routing of traffic within the network, and therefore between the ED 120 and the server 150. The nodes 140 are connected via a plurality of interconnections (shown in FIG. 1 as double-headed arrows), which provide different pathways for routing traffic within the network 130. A network node is available to be in the form of a: router (including a Multiprotocol Label Switching router); switch; firewall; gateway; access point; database; controller or processor; or virtualised network function.

The server 150 is configured to provide a service to the client device 110, for example in response to a service request from the client device. Services that are available to be provided by the server include data processing (e.g. storage, retrieval, transfer, analysis, manipulation, transformation and inspection) and a network service (e.g. routing, network configuration and security functions). Services are available to be provided by applications running on the server 150. The server 150 is available to form part of a plurality of interconnected servers, and in particular a Cloud system. The server 150 is accessible to the client device via the wide area network 130.

By means of the aforementioned components, and according to the method shown in, and described with reference to, FIG. 2, the ED is configured to route traffic between the client device and the server via network nodes 140 that are selected so as to meet requirements demanded by a service that is requested by the client device from the server; this is performed with the aim of improving network resource utilisation, secure data transport and processing.

In more detail, the ED 120 comprises a: Client Device Inspection Function (CDIF) 170; Service Requirement Identifier (SRI) 175; Policy Creator and Orchestrator (PCO) 180; and Capability Inspection Function (CIF) 185.

The CDIF 170 is provided so as to compile characteristic information associated with the client device 110. The CDIF is a device discovery and a traffic monitoring function that is configured to identify each client device connected to the ED, retrieve pre-defined characteristic information, and to monitor traffic to and from each client device so as to generate observed characteristic information for those client devices.

The pre-defined characteristic information for the client device is defined by an operator, manufacturer and/or vendor of the client device. In particular, the pre-defined characteristic information is static and is provided by the client device itself. For example, the pre-defined characteristic information is in the form of a Manufacturer Usage Description (MUD) file, as typically retrieved from a network resource accessible to the ED via the wide area network 130, for example, on the Internet via a URL provided by, or associated with the client device 110, or by inspecting DHCP traffic associated with the client device.

The CDIF is configured to inspect traffic to and/or from the client device 110, and based on said traffic, the CDIF is also configured to generate observed characteristic information for the client device 110. The observed characteristic information represents a dynamic behaviour profile for the client device based on analysis of network communications between the client device and the ED 120, wide area network 130 and/or the server 150. For example, the observed client device information is available to include:
temporal information, such as frequency, timings and/or duration of network communications;
geographic information based on network address geolocation;
network usage information, such as volume of network traffic (uplink and/or downlink) and bandwidth usage;
network communication information, including usage of types network communication protocols (e.g. TCP, UDP) and security protocols (e.g. TLS), as well as network communication content, such as data type and/or packet content;
network service requests, including identities of historically-requested network services and DNS requests; and/or
network connection information, including type of access connection used (e.g. wireless local area network, cellular network, hybrid access, etc.).

The Service Requirement Identifier (SRI) 175 function is configured to retrieve service requirement information (also herein referred to as “service capability requirement”) regarding a computational service that the server 150 is configured to perform.

Service requirement information are requirements, and particularly computational requirements, of the wide area network 130 (and specifically, the plurality of network nodes 140) for the server to provide a given service over the wide area network 130. In one example, the service requirement information is provided to, and stored at, the SRI by the server 150.

The service requirement information for a given service is available to depend upon the characteristic information associated with the client device 110, such that different service requirement information is output for different types of client devices seeking the same service.

In a specific example, the service requirement information requires that: only certain types of client devices and network nodes may be used to communicate network communications associated with a given service and/or such network communications are configured according to a particular protocol, format and/or level of encryption.

The Capability Inspection Function (CIF) 185 is configured to retrieve computational capability information associated with a network node 140. The capability information is received at the CIF 185 from each of the network nodes in the wide area network 130; this may be performed by the network nodes “pushing” such information to the CIF 185 or by the CIF requesting, and then receiving, the information from each network node.

A computational capability pertains to computational characteristics and functionalities, and in particular in relation to security, such as: firewall, encryption, remediation, and VPN functionality, and/or to hardware and/or software version characteristics.

The PCO 180 is configured to identify a suitable route through the wide area network 130 for communications between the client device 150 and the server 150, based on reconciliation of the service requirement information and the capability information, and then to enforce such routing. For example, the PCO is available to configure: network routing policies; firewall parameters; a VPN; proxies; and DHCPs.

In this way, by using service requirement information, the ED 120 is capable of dynamically creating bespoke secure network communication paths to help securely route communications between the client device 110 and server 150 in a resource-efficient manner.

FIG. 2 shows an exemplary process 200 for operating the telecommunications network 100.

At a first step 210, the client device 110 establishes a connection with the wide area network 130, via the ED 120. In this way, the client device may communicate with the server 150. The client device subsequently communicates a service request so as to request a service from the server.

At a next step 220, prior to the server 150 executing the requested service, the ED identifies, by means of the CDIF 170, the client device 110 and subsequently determines characteristic information associated with the client device (i.e. by retrieving pre-defined characteristic information and/or by retrieving and/or generating observed characteristic information).

Furthermore, by means of the SRI 175, the ED identifies the requested service, for example, based on a destination network address of the service request (e.g. IP address, port number, URL, etc.). In dependence upon the identity of the requested service and the identified characteristic information for the client device 110, the SRI retrieves the service requirement information for the requested service.

The ED also retrieves, by means of the CIF 185, capability information in relation to the plurality of network nodes 140.

At a subsequent step 230, the PCO 180 compares the capability information of each network node 140 and the service requirement information so as to identify whether a given network node has capabilities that meets the requirements as provided in the retrieved service requirement information. The PCO subsequently selects a set of network nodes that are determined to be suitable (i.e. have the computational capabilities required by the requested service) and then routes network communications between the client device and the server using the suitable network nodes 240.

In a specific example, the client device 110 is a network-enabled personal medical mentoring device (e.g. a wearable heart monitor), that requests a data storage and processing service from the server 150. The client device therefore generates personally-sensitive medical data (or “Personally Identifiable Information”); this is determined from the pre-defined characteristic information, which is in the form of a Manufacturer Usage Description (MUD) file. The ED retrieves from the server service requirement information for the requested service, and in turn identifies that, for such devices, the requested service requires that data is only communicated using sufficient encryption and only using sufficient firewall capability.

In another example, the client device is a network-enabled CCTV security camera that requests a facial recognition service from the server 150. Again, in this example, the characteristic information for the client device provides that the data from the client device comprises sensitive personal data. As such, for such devices, then service requirement information requires that the data is only communicated using a TCP protocol, to a pre-defined endpoint, using a secure connection having Transport Layer Security, and with a bandwidth of at least 2 Mbits/s.

In both specific examples, according to the processing described with reference to steps 230 and 240, the PCO 180 therefore identifies, using the retrieved capability information, network nodes that are determined to be suitable for the requested service, and the PCO accordingly only routes data from the client device for the requested service via those suitable network nodes.

### Alternatives and Modifications

In an alternative, the SRI 175, PCO180 and the CIF 185 reside, instead of only within the ED 120, at least in part, within a or each network node 140; as a result, a/the network node/s is/are available to ascertain the service requirement information and capability information, and then to determine suitability pertaining to a given requested service.

In one example, the capability information and the service requirement information are in the forms of scores indicative of an extent to which a capability is provided. Accordingly, the network nodes for routing network communications associated with a requested service are selected so that the capability information score is at least equal to the service requirement information score. For efficiency, the difference between the capability information score and the service requirement information is minimised.

Each feature disclosed herein, and (where appropriate) as part of the claims and drawings may be provided independently or in any appropriate combination.

Any reference numerals appearing in the claims are for illustration only and shall not limit the scope of the claims.

1. A method of operating a telecommunications network, the telecommunications network comprising a client device, a server configured to provide a service for the client device, and a plurality of network nodes communicatively connecting the client device and the server, in which said method comprises the steps of:
identifying:
characteristic information associated with the client device;
the service for the client device;
in dependence upon the identified service and characteristic information, a service capability requirement for the provision of the identified service to the client device; and
capability information for each of the plurality of network nodes;
determining a given network node of the plurality of network nodes to be suitable in response to the capability information of said network node satisfying the identified service capability requirement; and
subsequently routing network communications associated with the identified service between the client device and the server via at least one of the plurality of network nodes that is determined to be suitable.

2. A method according to claim 1, wherein the characteristic information is retrieved from a network location provided by the client device, and in which said characteristic information is pre-defined.

3. A method according to claim 2, wherein the characteristic information is comprised within a Manufacturer Usage Description (MUD) file.

4. A method according to claim 1, wherein the characteristic information comprises observed characteristic information that is generated in dependence on monitored network communications associated with the client device within the telecommunications network.

5. A method according to claim 4, wherein the network communications are monitored as to: data protocols; time and/or frequency of communication; bandwidth usage; network addresses; encryption type; and/or packet content.

6. A method according to claim 1, wherein the characteristic information is indicative of a/an: type of the client device; function of the client device; type of data that is output by the client device; and/or operating status of the client device.

7. A method according to claim 1, wherein the capability information is indicative of a security capability.

8. A method according to claim 7, wherein the service capability requirement is a required security capability.

9. A method according to claim 1, wherein the service capability requirement is a required network function.

10. A method according to claim 1, wherein the capability information is indicative of the client device generating Personally Identifiable Information (PII).

11. A method according to claim 1, wherein the routing of network communications is only performed via the at least one network node that is determined to be suitable.

12. A method according to claim 1, wherein the service is a network function and/or a data processing function.

13. A computer-readable carrier medium comprising a computer program, which, when the computer program is executed by a computer, causes the computer to carry out the steps of claim 1.

14. An apparatus for a telecommunications network, said telecommunications network comprising a client device, a server configured to provide a service for the client device, a plurality of network nodes communicatively connecting the client device and the server, the apparatus comprising:
a processor configured to perform the steps of:
identifying:
characteristic information associated with the client device;
the service for the client device;
in dependence upon the identified service and characteristic information, a service capability requirement for the provision of the service by the server to the client device; and
capability information for each of the plurality of network nodes;
determining a given network node to be suitable in response to the capability information of said network node satisfying the identified service capability requirement; and
subsequently routing network communications associated with the identified service between the client device and the server via at least one of the plurality of network nodes that is determined to be suitable.

15. An apparatus according to claim 14, wherein the apparatus is in the form of an edge device for providing an access network for the client device to access the plurality of network nodes, wherein the processor is provided, at least, as part of the edge device.
